(19) United States
(12) Patent Application Publication
(10) Pub. No.: US 2025/0315882 A1
(43) Pub. Date: Oct. 9, 2025

(54) SYSTEM AND METHOD FOR ORDER MANAGEMENT

(71) Applicant: 17LIVE Japan INC., Tokyo (JP)

(72) Inventors: Chou-Keng WU, Taipei City (TW); Chun-Hao LIEN, Taipei City (TW); Jing-Hong LIN, Taipei City (TW)

(21) Appl. No.: 19/094,300

(22) Filed: Mar. 28, 2025

(30) Foreign Application Priority Data
Apr. 8, 2024 (JP) 2024-061842
Jun. 4, 2024 (JP) 2024-090992

(51) Int. Cl. G06Q 30/0601; G06Q 10/087; G06Q 50/00

(52) U.S. Cl. CPC G06Q 30/0643; G06Q 10/087; G06Q 50/01

(57) ABSTRACT

The present disclosure relates to a terminal and a method for order management. The method includes: displaying an object associated with a post on a website supported by a first server on a user terminal of a first user; detecting the first user to have selected the object; transmitting a purchase comment from a second user and related to the post to a second server, wherein the first server is different from the second server.

### CROSS-REFERENCE TO RELATED APPLICATIONS

This application is based on and claims the benefit of priority from Japanese Patent Application Serial No. 2024-090992 filed on Jun. 4, 2024 which claims priority to Japanese Patent Application Serial No. 2024-061842 filed on Apr. 8, 2024, the contents of which are hereby incorporated by reference in their entirety.

### BACKGROUND OF THE DISCLOSURE

### Technical Field

The present disclosure relates to order management and, more particularly, to order management using a browser extension.

### Description Of Related Art

Sales and shopping on the Internet, such as on a social media platform or on an ecommerce website, has become popular in our daily life. There are various platforms or providers providing the service of online sales or order management, and the competition is fierce. It is important for a provider to provide its users their desired services.

Taiwan patent application publication TW202036427 discloses a system for order management.

### SUMMARY OF THE INVENTION

A method according to one embodiment of the present disclosure is a method for order management being executed by one or a plurality of computers, and includes: displaying an object associated with a post on a website supported by a first server on a user terminal of a first user; detecting the first user to have selected the object; transmitting a purchase comment from a second user and related to the post to a second server, wherein the first server is different from the second server.

A terminal according to one embodiment of the present disclosure is a terminal for order management that includes one or a plurality of processors, and the one or plurality of computer processors execute a browser plugin to perform: displaying an object associated with a post on a website supported by a first server on a user terminal of a first user; detecting the first user to have selected the object; transmitting a purchase comment from a second user and related to the post to a second server, wherein the first server is different from the second server.

A non-transitory computer-readable medium including a plugin program for order management, wherein the plugin program causes one or a plurality of computers to execute: displaying an object associated with a post on a website supported by a first server on a user terminal of a first user; detecting the first user to have selected the object; transmitting a purchase comment from a second user and related to the post to a second server, wherein the first server is different from the second server.

### BRIEF DESCRIPTION OF THE DRAWINGS

FIG. 1 shows a schematic configuration of a live streaming system 1 according to some embodiments of the present disclosure.

FIG. 2 is a block diagram showing functions and configuration of the user terminal 30 of FIG. 1 according to some embodiments of the present disclosure.

FIG. 3 shows a block diagram illustrating functions and configuration of the server of FIG. 1 according to some embodiments of the present disclosure.

FIG. 4 is a data structure diagram of an example of the stream DB 310 of FIG. 3.

FIG. 5 is a data structure diagram showing an example of the user DB 312 of FIG. 3.

FIG. 6 is a data structure diagram showing an example of the gift DB 314 of FIG. 3.

FIG. 7 is a data structure diagram showing an example of the item DB 250.

FIG. 8 is a data structure diagram showing an example of the order DB 350.

FIG. 9 is a data structure diagram showing an example of the stock DB 352.

FIG. 10 shows an exemplary flow according to some embodiments of the present disclosure.

FIG. 11 shows an example of a social media page from the administrator's view according to some embodiments of the present disclosure.

FIG. 12 shows an example of a social media page from the administrator's view according to some embodiments of the present disclosure.

FIG. 13 shows an example of a social media page from the administrator's view according to some embodiments of the present disclosure.

FIG. 14 shows an example of a social media page from the administrator's view according to some embodiments of the present disclosure.

FIG. 15 shows an example of a social media page from the buyer view according to some embodiments of the present disclosure.

FIG. 16 shows an example of a social media page from the buyer view according to some embodiments of the present disclosure.

FIG. 17 shows an example of a social media page from the buyer view according to some embodiments of the present disclosure.

FIG. 18 shows an example of a social media page from the buyer view according to some embodiments of the present disclosure.

FIG. 19 shows an example of a social media page from the buyer view according to some embodiments of the present disclosure.

FIG. 20 is a block diagram showing an example of a hardware configuration of the information processing device according to some embodiments of the present disclosure.

FIG. 21 shows an example of a social media page according to some embodiments of the present disclosure.

FIG. 22 shows a flowchart showing a process to generate data from comments at the user terminal with the plugin to the browser according to some embodiments of the present disclosure.

FIG. 23 shows data structure of an exemplary extracted order list 702.

FIG. 24 shows data structure of an exemplary extracted product list 704.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

An online sales provider (or order management service provider) would like to improve the shopping experience for its buyers (such as automatic order confirmation) and to improve the selling experience (such as order management) for its sellers.

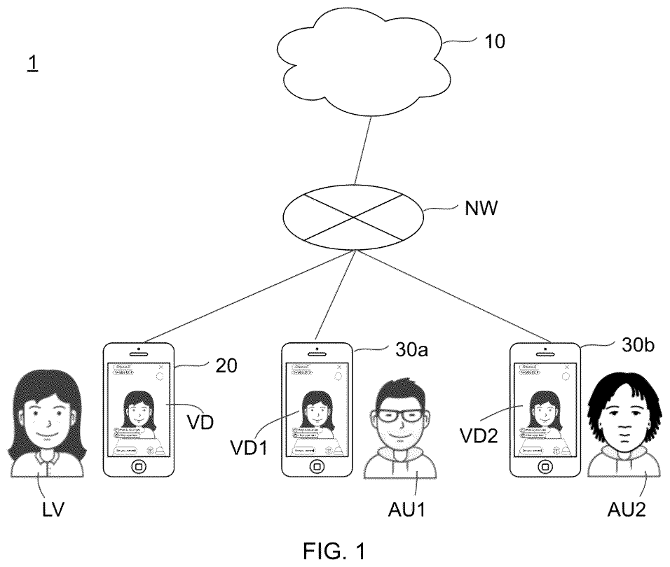

FIG. 1 shows a schematic configuration of a live streaming system 1 according to some embodiments of the present disclosure. The live streaming system 1 provides a live streaming service for the streaming streamer (could be referred to as liver, anchor, distributor, or livestreamer) LV and viewer (could be referred to as audience) AU (AU1, AU2 . . . ) to interact or communicate in real time. As shown in FIG. 1, the live streaming system 1 includes a server 10, a user terminal 20 and user terminals 30 (30a, 30b. . . ). In some embodiments, the streamers and viewers may be collectively referred to as users. The server 10 may include one or a plurality of information processing devices connected to a network NW. The user terminal 20 and 30 may be, for example, mobile terminal devices such as smartphones, tablets, laptop PCs, recorders, portable gaming devices, and wearable devices, or may be stationary devices such as desktop PCs. The server 10, the user terminal 20 and the user terminal 30 are interconnected so as to be able to communicate with each other over the various wired or wireless networks NW.

The live streaming system 1 involves the distributor LV, the viewers AU, and an administrator (or an APP provider, not shown) who manages the server 10. The distributor LV is a person who broadcasts contents in real time by recording the contents with his/her user terminal 20 and uploading them directly or indirectly to the server 10. Examples of the contents may include the distributor's own songs, talks, performances, gameplays, and any other contents. The administrator provides a platform for live-streaming contents on the server 10, and also mediates or manages real-time interactions between the distributor LV and the viewers AU. The viewer AU accesses the platform at his/her user terminal 30 to select and view a desired content. During live-streaming of the selected content, the viewer AU performs operations to comment, cheer, or send gifts via the user terminal 30. The distributor LV who is delivering the content may respond to such comments, cheers, or gifts. The response is transmitted to the viewer AU via video and/or audio, thereby establishing an interactive communication.

The term “live-streaming” may mean a mode of data transmission that allows a content recorded at the user terminal 20 of the distributor LV to be played or viewed at the user terminals 30 of the viewers AU substantially in real time, or it may mean a live broadcast realized by such a mode of transmission. The live-streaming may be achieved using existing live delivery technologies such as HTTP Live Streaming, Common Media Application Format, Web Real-Time Communications, Real-Time Messaging Protocol and MPEG DASH. Live-streaming includes a transmission mode in which the viewers AU can view a content with a specified delay simultaneously with the recording of the content by the distributor LV. As for the length of the delay, it may be acceptable for a delay with which interaction between the distributor LV and the viewers AU can be established. Note that the live-streaming is distinguished from so-called on-demand type transmission, in which the entire recorded data of the content is once stored on the server, and the server provides the data to a user at any subsequent time upon request from the user.

The term “video data” herein refers to data that includes image data (also referred to as moving image data) generated using an image capturing function of the user terminals 20 or 30, and audio data generated using an audio input function of the user terminals 20 or 30. Video data is reproduced in the user terminals 20 and 30, so that the users can view contents. In some embodiments, it is assumed that between video data generation at the distributor's user terminal 20 and video data reproduction at the viewer's user terminal 30, processing is performed onto the video data to change its format, size, or specifications of the data, such as compression, decompression, encoding, decoding, or transcoding. However, the content (e.g., video images and audios) represented by the video data before and after such processing does not substantially change, so that the video data after such processing is herein described as the same as the video data before such processing. In other words, when video data is generated at the distributor's user terminal 20 and then played back at the viewer's user terminal 30 via the server 10, the video data generated at the distributor's user terminal 20, the video data that passes through the server 10, and the video data received and reproduced at the viewer's user terminal 30 are all the same video data.

In the example in FIG. 1, the distributor LV provides the live streaming data. The user terminal 20 of the distributor LV generates the streaming data by recording images and sounds of the distributor LV, and the generated data is transmitted to the server 10 over the network NW. At the same time, the user terminal 20 displays a recorded video image VD of the distributor LV on the display of the user terminal 20 to allow the distributor LV to check the live streaming contents currently performed.

The user terminals 30a and 30b of the viewers AU1 and AU2 respectively, who have requested the platform to view the live streaming of the distributor LV, receive video data related to the live streaming (may also be herein referred to as “live-streaming video data”) over the network NW and reproduce the received video data to display video images VD1 and VD2 on the displays and output audio through the speakers. The video images VD1 and VD2 displayed at the user terminals 30a and 30b, respectively, are substantially the same as the video image VD captured by the user terminal 20 of the distributor LV, and the audio outputted at the user terminals 30a and 30b is substantially the same as the audio recorded by the user terminal 20 of the distributor LV.

Recording of the images and sounds at the user terminal 20 of the distributor LV and reproduction of the video data at the user terminals 30a and 30b of the viewers AU1 and AU2 are performed substantially simultaneously. Once the viewer AU1 types a comment about the contents provided by the distributor LV on the user terminal 30a, the server 10 displays the comment on the user terminal 20 of the distributor LV in real time and also displays the comment on the user terminals 30a and 30b of the viewers AU1 and AU2, respectively. When the distributor LV reads the comment and develops his/her talk to cover and respond to the comment, the video and sound of the talk are displayed on the user terminals 30a and 30b of the viewers AU1 and AU2, respectively. This interactive action is recognized as the establishment of a conversation between the distributor LV and the viewer AU1. In this way, the live streaming system 1 realizes the live streaming that enables interactive communication, not one-way communication.

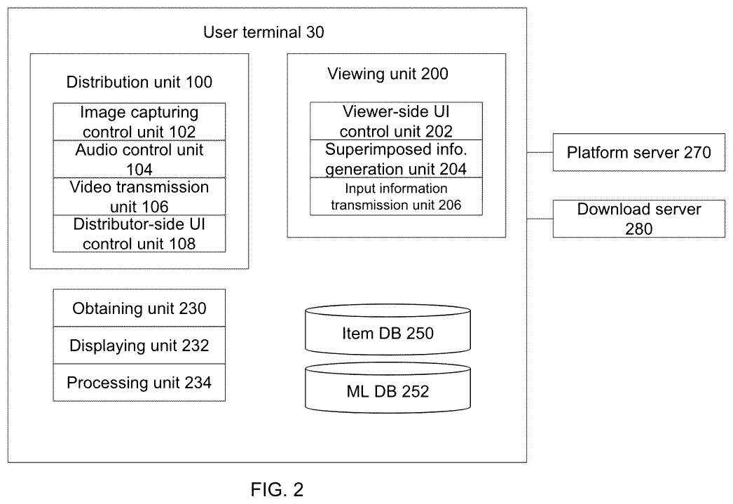

FIG. 2 is a block diagram showing functions and configuration of the user terminal 30 of FIG. 1 according to some embodiments of the present disclosure. The user terminal 20 has the same or similar functions and configuration as the user terminal 30. Each block in FIG. 2 and the subsequent block diagrams may be realized by elements such as a computer CPU or a mechanical device in terms of hardware, and can be realized by a computer program or the like in terms of software. Functional blocks could be realized by cooperative operation between these elements. Therefore, it is understood by those skilled in the art that these functional blocks can be realized in various forms by combining hardware and software.

The distributor LV and the viewers AU may download and install a live streaming application program (hereinafter referred to as a live streaming application) to the user terminals 20 and 30 from a download site over the network NW. Alternatively, the live streaming application may be pre-installed on the user terminals 20 and 30. When the live streaming application is executed on the user terminals 20 and 30, the user terminals 20 and 30 communicate with the server 10 over the network NW to implement or execute various functions. Hereinafter, the functions implemented by the user terminals 20 and 30 (processors such as CPUs) in which the live streaming application is run will be described as functions of the user terminals 20 and 30. These functions are realized in practice by the live streaming application on the user terminals 20 and 30. In some embodiments, these functions may be realized by a computer program that is written in a programming language such as HTML (HyperText Markup Language), transmitted from the server 10 to web browsers of the user terminals 20 and 30 over the network NW, and executed by the web browsers.

The user terminal 30 includes a distribution unit 100 and a viewing unit 200. The distribution unit 100 generates video data in which the user's (or the user side's) image and sound are recorded, and provides the video data to the server 10. The viewing unit 200 receives video data from the server 10 to reproduce the video data. The user activates the distribution unit 100 when the user performs live streaming, and activates the viewing unit 200 when the user views a video. The user terminal in which the distribution unit 100 is activated is the distributor's terminal, i.e., the user terminal that generates the video data. The user terminal in which the viewing unit 200 is activated is the viewer's terminal, i.e., the user terminal in which the video data is reproduced and played.

The distribution unit 100 includes an image capturing control unit 102, an audio control unit 104, a video transmission unit 106, and a distributor-side UI control unit 108. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time. The distributor-side UI control unit 108 controls an UI (user interface) for the distributor. The distributor-side UI control unit 108 may be connected to a display (not shown in FIG. 2), and displays a video on the display by reproducing the video data that is to be transmitted by the video transmission unit 106. The distributor-side UI control unit 108 may display an operation object or an instruction-accepting object on the display, and accepts inputs from the distributor who taps on the object.

The viewing unit 200 includes a viewer-side UI control unit 202, a superimposed information generation unit 204, and an input information transmission unit 206. The viewing unit 200 receives, from the server 10 over the network NW, video data related to the live streaming in which the distributor, the viewer who is the user of the user terminal 30, and other viewers participate. The viewer-side UI control unit 202 controls the UI for the viewers. The viewer-side UI control unit 202 is connected to a display and a speaker (not shown in FIG. 2), and reproduces the received video data to display video images on the display and output audio through the speaker. The state where the image is outputted to the display and the audio is outputted from the speaker can be referred to as “the video data is played”. The viewer-side UI control unit 202 is also connected to input means (not shown in FIG. 2) such as touch panels, keyboards, and displays, and obtains user input via these input means. The superimposed information generation unit 204 superimposes a predetermined frame image on an image generated from the video data from the server 10. The frame image includes various user interface objects (hereinafter simply referred to as “objects”) for accepting inputs from the user, comments entered by the viewers, and/or information obtained from the server 10. The input information transmission unit 206 transmits the user input obtained by the viewer-side UI control unit 202 to the server 10 over the network NW.

In some embodiments, the user terminal 20 could be a terminal of a seller (or administrator, or merchant) for selling items on a sales website (or an ecommerce site, or a social media page including the sales function). The selling activity may include creating a sales post on the sales website. In some embodiments, the post may include live streaming content. In some embodiments, the user terminal 30 could be a terminal of a buyer (or visitor) for buying or browsing items on a sales website or on an ecommerce site. The buying activity may include leaving comments with respect to the sales post.

The user terminal 30 (or the user terminal 20) also includes an obtaining unit 230, a displaying unit 232, a processing unit 234, an item DB 250, and a ML DB 252. The user terminal 30 communicates with a platform server 270 and a download server 280.

The platform server 270 is a server (or a 3rd party server) supporting or operating a sales website, which could include any ecommerce platform or social media platform, such as Facebook or Instagram.

The download server 280 is a server wherein programs/applications/plugins/program extensions could be downloaded. For example, it could be a server for the google play store, for the apple store, or for an extension downloading space. The extension downloading space could be the place wherein a browser extension, such as a chrome extension, could be accessed.

In some embodiments, the obtaining unit 230, the displaying unit 232, the processing unit 234, the item DB 250, and/or the ML DB 252 could be realized (or included) by an extension downloaded from the download server 280. In some embodiments, the extension could be installed into an application, such as a browser, on the user terminal 30 (or user terminal 20).

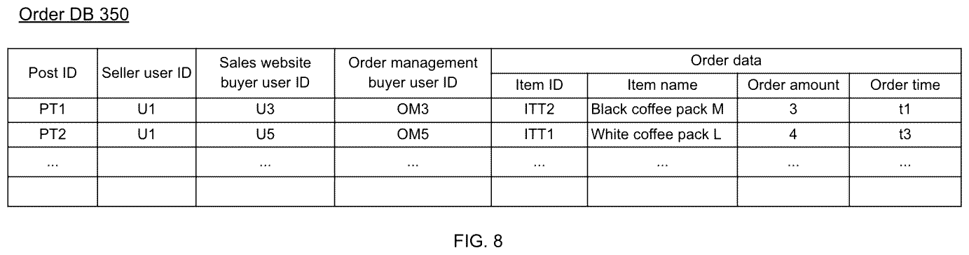

FIG. 7 is a data structure diagram showing an example of the item DB 250. The item DB 250 stores data of the items to be sold on a sales website. The item DB 250 stores the item ID and the item name, in association with each other. In some embodiments, the data in the item DB 250 could be set by a seller of a user terminal 20 to be in line with a sales post on the sales website. In some embodiments, the data in the item DB 250 could be set by the obtaining unit 230 or the processing unit 234 by extracting the content of the sales post on the sales website.

The ML DB 252 could include various AI or machine learning models such as large language models (LLM) including, for example, ChatGPT.

The obtaining unit 230 is configured to obtain website data or ecommerce data from the platform server 270.

The displaying unit 232 is configured to display the website supported or operated by the platform server 270, according to the website data obtained by the obtaining unit 230. The website may include one or more sales posts. In some embodiments, the display function could be performed by the viewing unit 200. In some embodiments, the website is accessed by a browser of the user terminal 20, and the extension including the displaying unit 232 is installed into the browser.

The processing unit 234 is configured to determine whether or not a content on the website has met a predetermined criterion. For example, the processing unit 234 may crawl/extract/scan the website (or webpage) data to determine if the user who is accessing the website is a seller/administrator on the website. The predetermined criterion may require the content to include some keyword, such as “administrator” or “seller” that indicates the user is a seller on the website. In some embodiments, the user has to log in the website as a seller/administrator first. The keyword may vary according to different websites and can be set according to actual practice.

If the user is determined to be a seller, the displaying unit 232 displays a login object/interface that is configured for the user to log in an order management service provided by the server 10. In the login process, the obtaining unit 230 obtains an identifier from the seller, the identifier associated with the sales website (or the sales post) and the order management service provided by server 10. In some embodiment, the identifier could be a user ID of the seller on the sales website. In some embodiments, the identifier could be a user ID of the seller on the order management service system.

In response to or after successful login into the order management service, the displaying unit 232 displays an export object associated with a sales post on the website. The export object could be displayed along with the sales post.

The processing unit 234 is configured to detect the seller to have selected the export object. The processing unit 234 may then extract one or more purchase comments related to the sales post and transmit the purchase comments to the order management server 10, for subsequent order management. The transmission may be tied to or may be linked to the identifier of the seller. The purchase comments are left from other users or buyers on the website. The processing unit 234 may also extract other order information and send the order information to server 10 for order management. The order information may include the post ID of the sales post, the user ID of the seller, the user ID of the buyers, and/or the order time (or commenting time), for example.

In some embodiments, the processing unit 234 may utilize the ML DB 252 to analyze and determine the purchase information from the purchase comment. For example, a LLM from the ML DB 252 could be utilized to confirm, by referring to the item DB 250, which item and how many items a buyer wants based on the buyer's comment. In some embodiments, the processing unit 234 may transmit the determined purchase information (including the determined item name and number) to server 10, instead of transmitting the original purchase comment.

In some embodiments, the processing unit 234 may find out or determine a portion of the purchase comment to be inconsistent with the set of items in the item DB 250. In that case, the processing unit 234 may utilize the ML DB 252 to determine a candidate item, in the set of items in the item DB 250, that is correlated (or the most correlated) with the portion of the purchase comment. The processing unit 234 may then generate a confirmation comment with respect to the post (or with respect to the purchase comment), wherein the confirmation comment includes the candidate item

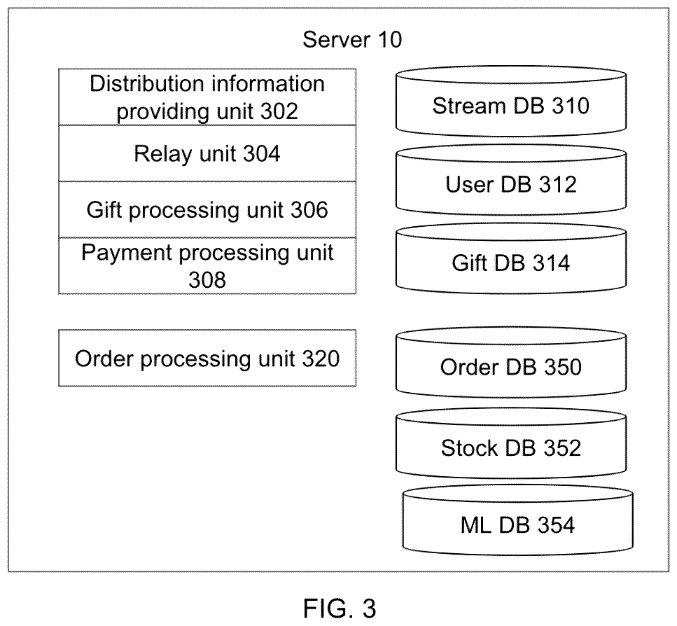

FIG. 3 shows a block diagram illustrating functions and configuration of the server 10 of FIG. 1 according to some embodiments of the present disclosure. The server 10 includes a distribution information providing unit 302, a relay unit 304, a gift processing unit 306, a payment processing unit 308, a stream DB 310, a user DB 312, a gift DB 314, an order processing unit 320, a notifying unit 322, an order DB 350, a stock DB 352, and an ML DB 354.

Upon reception of a notification or a request from the user terminal 20 on the distributor side to start a live streaming over the network NW, the distribution information providing unit 302 registers a stream ID for identifying this live streaming and the distributor ID of the distributor who performs the live streaming in the stream DB 310.

When the distribution information providing unit 302 receives a request to provide information about live streams from the viewing unit 200 of the user terminal 30 on the viewer side over the network NW, the distribution information providing unit 302 retrieves or checks currently available live streams from the stream DB 310 and makes a list of the available live streams. The distribution information providing unit 302 transmits the generated list to the requesting user terminal 30 over the network NW. The viewer-side UI control unit 202 of the requesting user terminal 30 generates a live stream selection screen based on the received list and displays it on the display of the user terminal 30.

Once the input information transmission unit 206 of the user terminal 30 receives the viewer's selection result on the live stream selection screen, the input information transmission unit 206 generates a distribution request including the stream ID of the selected live stream, and transmits the request to the server 10 over the network NW. The distribution information providing unit 302 starts providing, to the requesting user terminal 30, the live stream specified by the stream ID included in the received distribution request. The distribution information providing unit 302 updates the stream DB 310 to include the user ID of the viewer of the requesting user terminal 30 into the viewer IDs of (or corresponding to) the stream ID.

The relay unit 304 relays the video data from the distributor-side user terminal 20 to the viewer-side user terminal 30 in the live streaming started by the distribution information providing unit 302. The relay unit 304 receives from the input information transmission unit 206 a signal that represents user input by a viewer during the live streaming or reproduction of the video data. The signal that represents user input may be an object specifying signal for specifying an object displayed on the display of the user terminal 30. The object specifying signal may include the viewer ID of the viewer, the distributor ID of the distributor of the live stream that the viewer watches, and an object ID that identifies the object. When the object is a gift, the object ID is the gift ID. Similarly, the relay unit 304 receives, from the distribution unit 100 of the user terminal 20, a signal that represents user input performed by the distributor during reproduction of the video data (or during the live streaming). The signal could be an object specifying signal.

Alternatively, the signal that represents user input may be a comment input signal including a comment entered by a viewer into the user terminal 30 and the viewer ID of the viewer. Upon reception of the comment input signal, the relay unit 304 transmits the comment and the viewer ID included in the signal to the user terminal 20 of the distributor and the user terminals 30 of other viewers. In these user terminals 20 and 30, the viewer-side UI control unit 202 and the superimposed information generation unit 204 display the received comment on the display in association with the viewer ID also received.

The gift processing unit 306 updates the user DB 312 so as to increase the points of the distributor depending on the points of the gift identified by the gift ID included in the object specifying signal. Specifically, the gift processing unit 306 refers to the gift DB 314 to specify the points to be granted for the gift ID included in the received object specifying signal. The gift processing unit 306 then updates the user DB 312 to add the determined points to the points of (or corresponding to) the distributor ID included in the object specifying signal.

The payment processing unit 308 processes payment of a price of a gift from a viewer in response to reception of the object specifying signal. Specifically, the payment processing unit 308 refers to the gift DB 314 to specify the price points of the gift identified by the gift ID included in the object specifying signal. The payment processing unit 308 then updates the user DB 312 to subtract the specified price points from the points of the viewer identified by the viewer ID included in the object specifying signal.

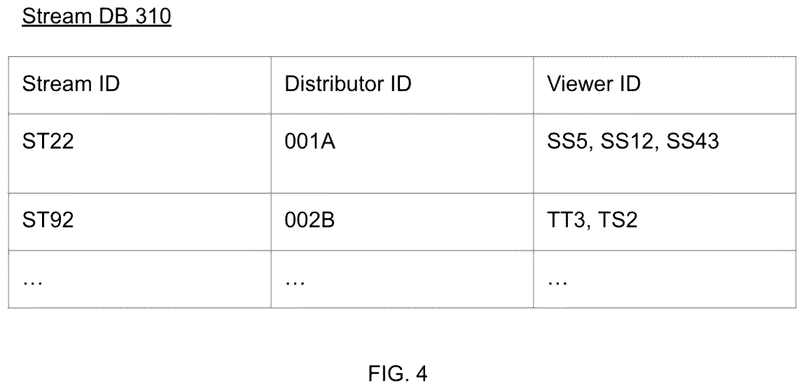

FIG. 4 is a data structure diagram of an example of the stream DB 310 of FIG. 3. The stream DB 310 holds information regarding a live stream currently taking place. The stream DB 310 stores the stream ID, the distributor ID, and the viewer ID, in association with each other. The stream ID is for identifying a live stream on a live streaming platform provided by the live streaming system 1. The distributor ID is a user ID for identifying the distributor who provides the live stream. The viewer ID is a user ID for identifying a viewer of the live stream. In the live streaming platform provided by the live streaming system 1 of some embodiments, when a user starts a live stream, the user becomes a distributor, and when the same user views a live stream broadcast by another user, the user also becomes a viewer. Therefore, the distinction between a distributor and a viewer is not fixed, and a user ID registered as a distributor ID at one time may be registered as a viewer ID at another time.

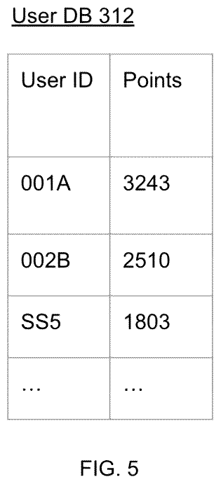

FIG. 5 is a data structure diagram showing an example of the user DB 312 of FIG. 3. The user DB 312 holds information regarding users. The user DB 312 stores the user ID and the point, in association with each other. The user ID identifies a user. The point corresponds to the points the corresponding user holds. The point is the electronic value circulated within the live streaming platform. In some embodiments, when a distributor receives a gift from a viewer during a live stream, the distributor's points increase by the value corresponding to the gift. The points are used, for example, to determine the amount of reward (such as money) the distributor receives from the administrator of the live streaming platform. In some embodiments, when the distributor receives a gift from a viewer, the distributor may be given the amount of money corresponding to the gift instead of the points.

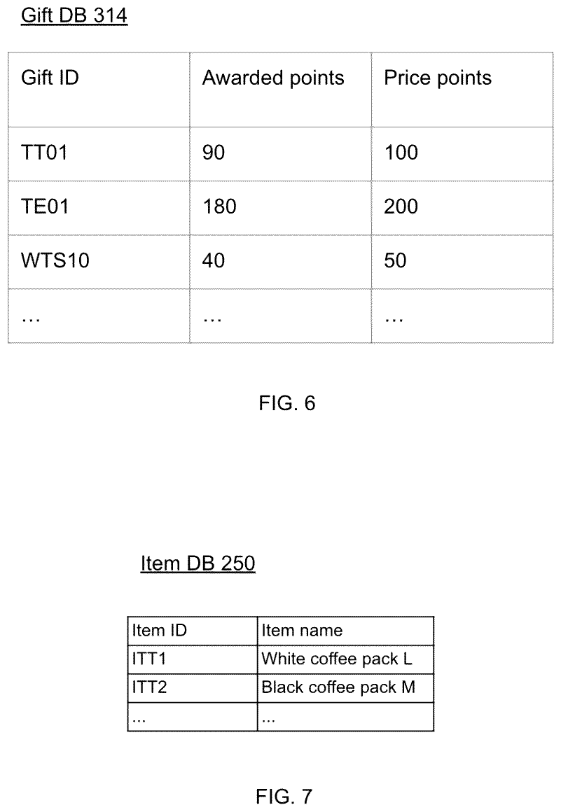

FIG. 6 is a data structure diagram showing an example of the gift DB 314 of FIG. 3. The gift DB 314 holds information regarding gifts available for the viewers in the live streaming. A gift is electronic data. A gift may be purchased with the points or money, or can be given for free. A gift may be given by a viewer to a distributor. Giving a gift to a distributor is also referred to as using, sending, or throwing the gift. Some gifts may be purchased and used at the same time, and some gifts may be purchased and then used at any time later by the purchaser viewer. When a viewer gives a gift to a distributor, the distributor is awarded the amount of points corresponding to the gift. When a gift is used, the use may trigger an effect associated with the gift. For example, an effect (such as visual or sound effect) corresponding to the gift will appear on the live streaming screen.

The gift DB 314 stores the gift ID, the awarded points, and the price points, in association with each other. The gift ID is for identifying a gift. The awarded points are the amount of points awarded to a distributor when the gift is given to the distributor. The price points are the amount of points to be paid for use (or purchase) of the gift. A viewer is able to give a desired gift to a distributor by paying the price points of the desired gift when the viewer is viewing the live stream. The payment of the price points may be made by an appropriate electronic payment means. For example, the payment may be made by the viewer paying the price points to the administrator. Alternatively, bank transfers or credit card payments may be used. The administrator is able to desirably set the relationship between the awarded points and the price points. For example, it may be set as the awarded points=the price points. Alternatively, points obtained by multiplying the awarded points by a predetermined coefficient such as 1.2 may be set as the price points, or points obtained by adding predetermined fee points to the awarded points may be set as the price points.

In some embodiments, the server 10 could be a server operating an order management service system. The order management system could be configured to help a seller/administrator of a sales website manage order data on the sales website.

The ML DB 354 could include various AI or machine learning models such as large language models (LLM) including, for example, ChatGPT.

FIG. 8 is a data structure diagram showing an example of the order DB 350. The order DB 350 stores the post ID, the seller user ID, the sales website buyer user ID, the order management buyer user ID, and the order data, in association with each other. The order data includes the item ID, the item name, the order amount, and the order time.

The post ID is configured to identify the sales post on the sales website. The seller user ID is the user ID of the seller of the sales post (or the sales website). The sales website buyer user ID is the user ID of the buyer of the sales post. The order management buyer user ID is the user ID in the order management service system provided by server 10. For example, by the order management buyer user ID, the server 10 may be able to access another database for the corresponding user data, including the name, the address and the deposit of the user, for example. The correspondence between the sales website buyer user ID and the order management buyer user ID could be realized in various ways in advance, according to the actual practice.

The data in the order DB 350 could be obtained, processed or analyzed, and stored into the order DB 350 by the order processing unit 320. For example, the order processing unit 320 obtains the purchase comments, the order information (such as post ID, seller user ID, buyer user ID) of a sales post from a seller side processing unit 234. For example, the order processing unit 320 may utilize the ML DB 354 to analyze the purchase comments and to extract the item ID, the item name, the order number, and/or the order time.

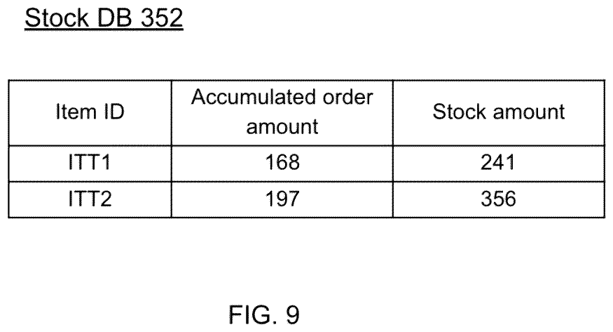

FIG. 9 is a data structure diagram showing an example of the stock DB 352. The stock DB 350 stores the item ID, the accumulated order amount, and the stock amount, in association with each other.

The accumulated order amount could be calculated from the order DB 350, by the order processing unit 320, for example. The stock amount indicates how many items are left for sale.

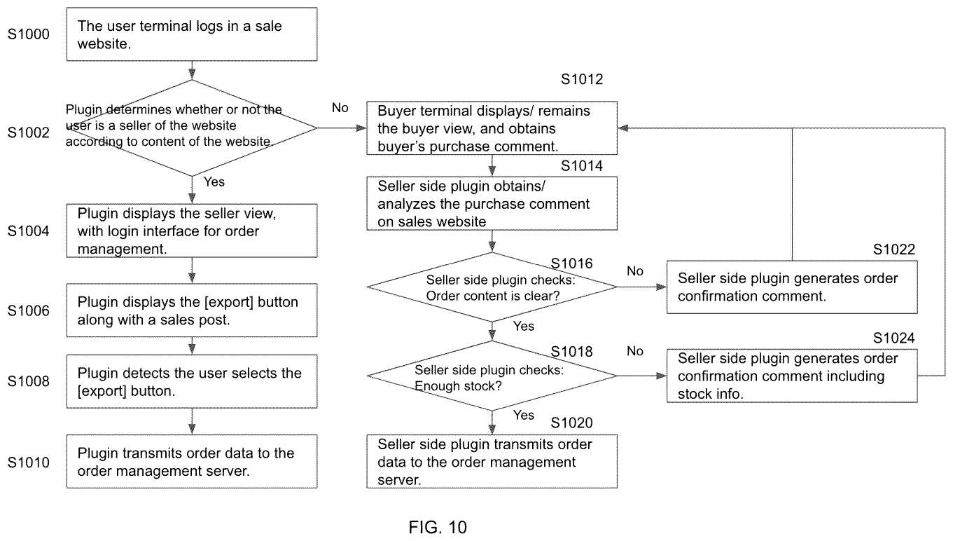

FIG. 10 shows an exemplary flow according to some embodiments of the present disclosure.

At step S1000, a user utilizes a browser of a user terminal to browse and log in a sales website. The browser has been installed with a plugin (or an extension) for order management.

At step S1002, the plugin determines whether or not the user is a seller (or administrator) of the sales website according to content of the website. If yes, the flow goes to step S1004. If no, the flow goes to step S1012.

At step S1004, the plugin displays the seller view, with a login interface for the user to log in an order management system operated by an order management server 10.

At step S1006, after successful login, the plugin displays the [export] button (or object) along with a sales post on the sales website. The button allows the user to extract data related to the sales post.

At step S1008, the plugin detects the user to have selected the [export] button.

At step S1010, the plugin transmits the order data (including information such as the post ID, the seller ID, the buyer ID, the purchase comments or the extracted purchase information) to the order management server 10. The order is then confirmed and will be executed subsequently.

If the flow goes to step S1012, it means the user logging in the sales website at step S1000 is a buyer instead of a seller.

At step S1012, the buyer user terminal displays (or remains in) the buyer view, without the login interface for the order management system. The buyer user terminal also obtains purchase comment from the buyer with respect to a sales post on the sales website.

At step S1014, a seller side plugin obtains/analyzes the purchase comment on the sales website. The seller side plugin is installed into a browser of a user terminal of a seller, who is the seller/administrator of the sales post (or the sales website).

At step S1016, the seller side plugin checks if the order content is clear. For example, the seller side processing unit 234 may utilize the ML DB 252 and the item DB250 to analyze the purchase comment to see if the buyer left a clear order message. If yes, the flow goes to step S1018. If no, the flow goes to step S1022.

At step S1022, the seller side plugin generates an order confirmation comment with respect to the sales post to confirm the order content with the buyer. The flow then goes back to step S1012 to obtain the buyer's purchase comment (or amended purchase comment).

At step S1018, the seller side plugin checks if the item stock is enough for the new order. For example, the seller side processing unit 234 may access the order DB 350 and/or the stock DB 352 on the order management server 10, and check if the order can be met. If yes, the flow goes to step S1020. If no, the flow goes to step S1024.

In step S1024, the seller side plugin generates an order confirmation comment with respect to the sales post to confirm the order content with the buyer. The confirmation comment includes the stock information. The flow then goes back to step S1012 to obtain the buyer's purchase comment (or amended purchase comment).

At step S1020, the seller side plugin transmits the order data (including information such as the post ID, the seller ID, the buyer ID, the purchase comments or the extracted purchase information) to the order management server 10. The order is then confirmed and will be executed subsequently.

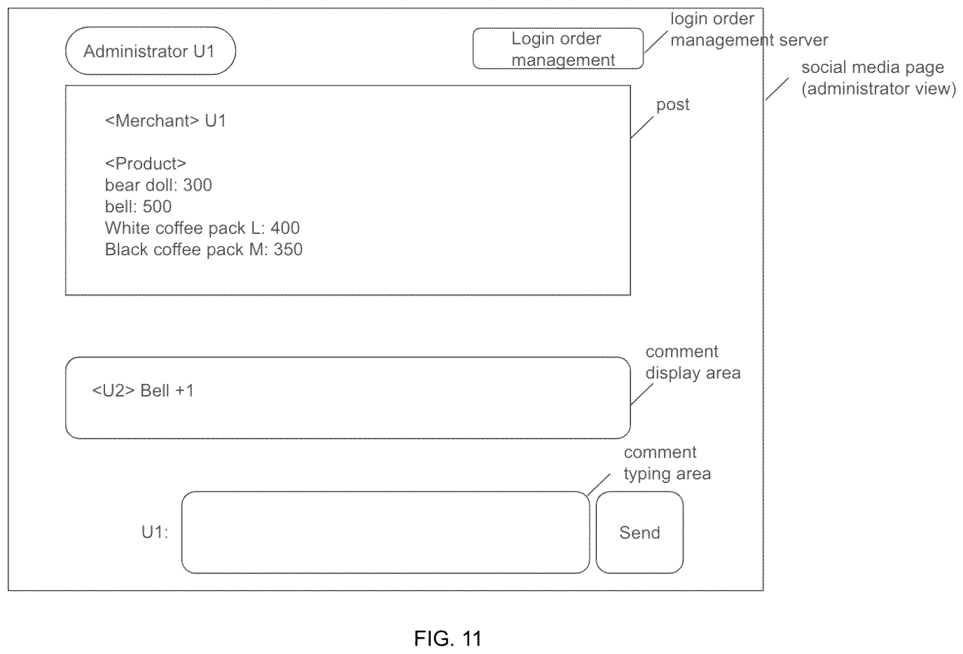

FIG. 11 shows an example of a social media page from the administrator's view according to some embodiments of the present disclosure. FIG. 11 may correspond to steps S1000, S1002, and S1004 in FIG. 10.

The social media page includes the sales post area, the comment display area, and the comment typing area. The sales post area includes contents of a sales post, including the merchant/seller name, the product name, and the product price. The comment display area is the area where comments related to the sales post are displayed. The comment typing area is for entering comments. The social media page is operated by a social media server. The social media could be, for example, Facebook, Instagram, TikTok, or X (formerly known as twitter).

Since the user U1 is an administrator (or seller/merchant) on the social media page, after logging in the social media page, the content [administrator U1] is shown on the page. The plugin installed in the browser of the user terminal of user U1 then determines user U1 to be an administrator of the social media page according to the content [administrator]. Then the plugin displays the [login order management] option for user U1 to log in the order management system, which is supported by an order management server 10.

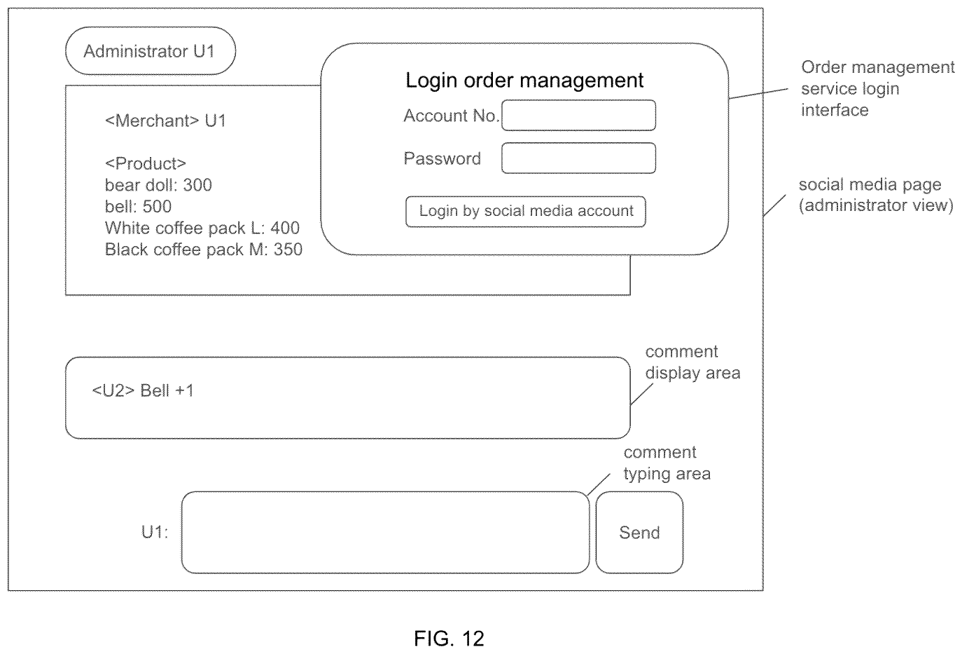

FIG. 12 shows an example of a social media page from the administrator's view according to some embodiments of the present disclosure. FIG. 12 may correspond to step S1004 in FIG. 10.

After user U1 selects [login order management] in FIG. 11, the plugin shows the login interface for user U1 to log in the order management service. User U1 may enter his/her identifier in the order management system to log in.

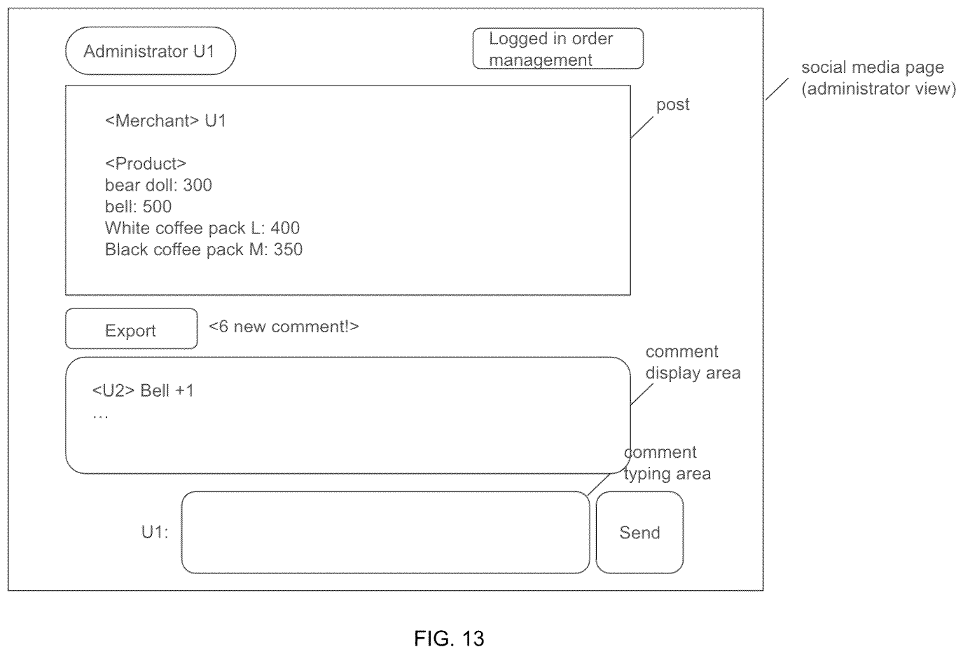

FIG. 13 shows an example of a social media page from the administrator's view according to some embodiments of the present disclosure. FIG. 13 may correspond to step S1006 in FIG. 10.

After successfully logging in the order management system, the plugin displays the [export] button along with the sales post. User U1 can select the button to extract and transmit the order data to the order management server 10 for subsequent analysis or order preparation. The order data may include the post ID, the user ID of user U1, the post contents, the comment data, and the user ID of the user who left the comment data.

The plugin also displays the number of new comments. New comments are comments newly left after the last exporting action. In some embodiments, the plugin may export any new comment automatically when it detects there is a new comment.

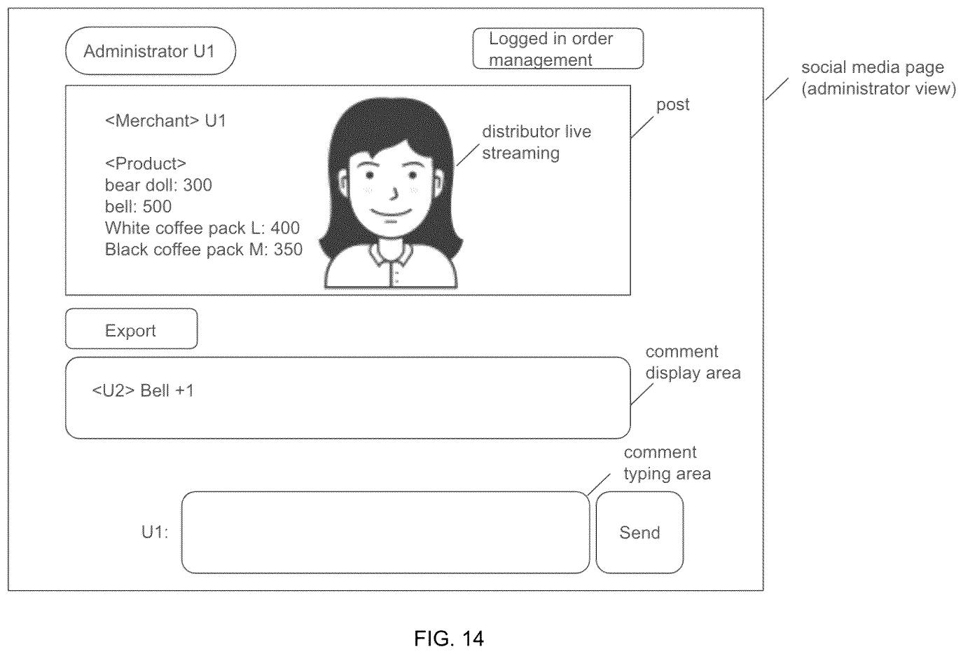

FIG. 14 shows an example of a social media page from the administrator's view according to some embodiments of the present disclosure. FIG. 14 is similar to FIG. 13 except that the sales post includes live streaming content, wherein a distributor or a seller could perform live selling in the post.

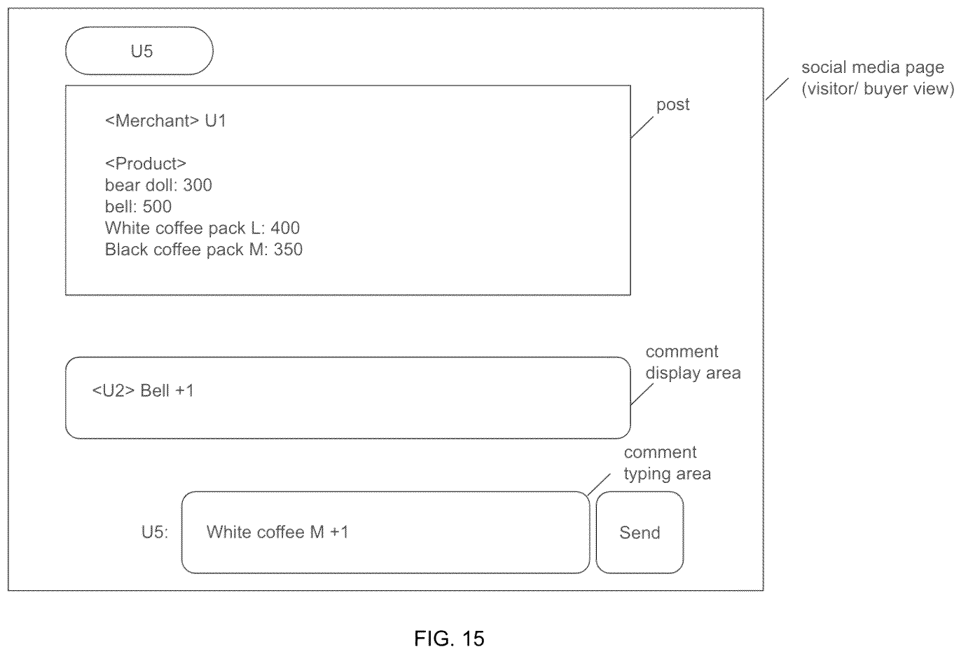

FIG. 15 shows an example of a social media page from the buyer view according to some embodiments of the present disclosure. FIG. 15 may correspond to steps S1000, S1002, and S1012 in FIG. 10.

The user U5 is a buyer/visitor, instead of an administrator, on the social media page (or with respect to the sales post). Therefore after logging in the social media page, the content [administrator] is not shown on the page.

The plugin installed in the browser of the user terminal of user U5 then determines user U5 to be a buyer/visitor of the social media page due to lack of the content [administrator]. Therefore the plugin does not display the [login order management] option for logging in the order management system. The user U5 enters the comment “White coffee M+1” to make an order.

In some embodiments, the user terminal of user U5 may not be installed with the plugin for communicating the order management server 10. In that case, step S1002 does not exist and the flow goes from step S1000 to step S1012 in FIG. 10.

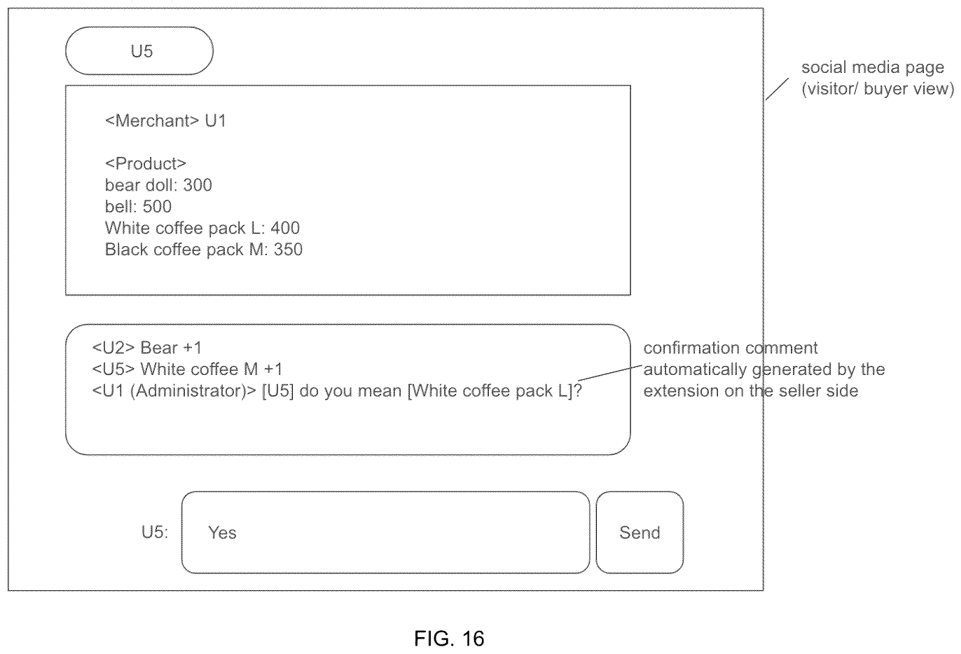

FIG. 16 shows an example of a social media page from the buyer view according to some embodiments of the present disclosure. FIG. 16 may correspond to steps S1014, S1016, S1022, and S1012 in FIG. 10.

The purchase comment “White coffee M+1” from user U5 is displayed on the comment display area. The plugin on the user terminal of user U1 (who is the merchant of the sales post) analyzes the comment and finds it to be inconsistent with the data in the item DB. The plugin then utilizes the ML DB to find the most possible item the user U5 means, that is “White coffee pack L”, and generates a confirmation comment to confirm with user U5.

User U5 may then reply to the confirmation comment to make the order clear. User U5 may then leave the comment “Yes”, which is then displayed in the comment display area. The seller (user U1) side plugin then determines (with the help of a LLM model, for example) a confirmation result with respect to the confirmation comment has been generated by the buyer U5 on the website (or with respect to the sales post). The seller side plugin then transmits the confirmation result to the order management server.

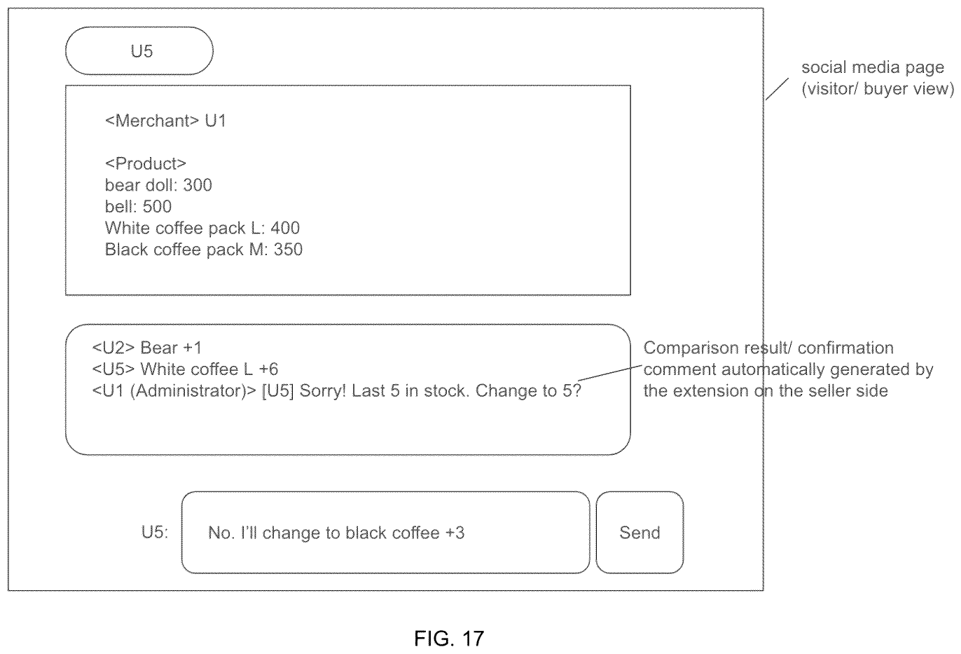

FIG. 17 shows an example of a social media page from the buyer view according to some embodiments of the present disclosure. FIG. 17 may correspond to steps S1014, S1016, S1018, S1024, and S1012 in FIG. 10.

The purchase comment “White coffee L+6” from user U5 is displayed on the comment display area. The plugin on the user terminal of user U1 (who is the merchant of the sales post) analyzes the comment and confirms the purchase item. The plugin accesses the stock DB in the order management server and found the stock is not enough to fulfill the order. Therefore, the plugin generates a confirmation comment including the stock information to confirm with user U5. User U5 may then reply to the confirmation comment to amend the order. In some embodiments, the processing unit 234 on the seller side user terminal may access the stock DB 352 of server 10 to determine the amount of order that can still be received from a buyer (or a new buyer). The process could be done automatically or periodically, or could be done every time there is a new order received.

In some embodiments, the seller side plugin performs a comparison between multiple purchase comments, from multiple buyers and related to the sales post, and the stock data. The seller side plugin then generates a result with respect to the sales post. For example, the result may be a comment indicating the stock is not enough for a new order. Or the result may be a comment indicating how many items are left.

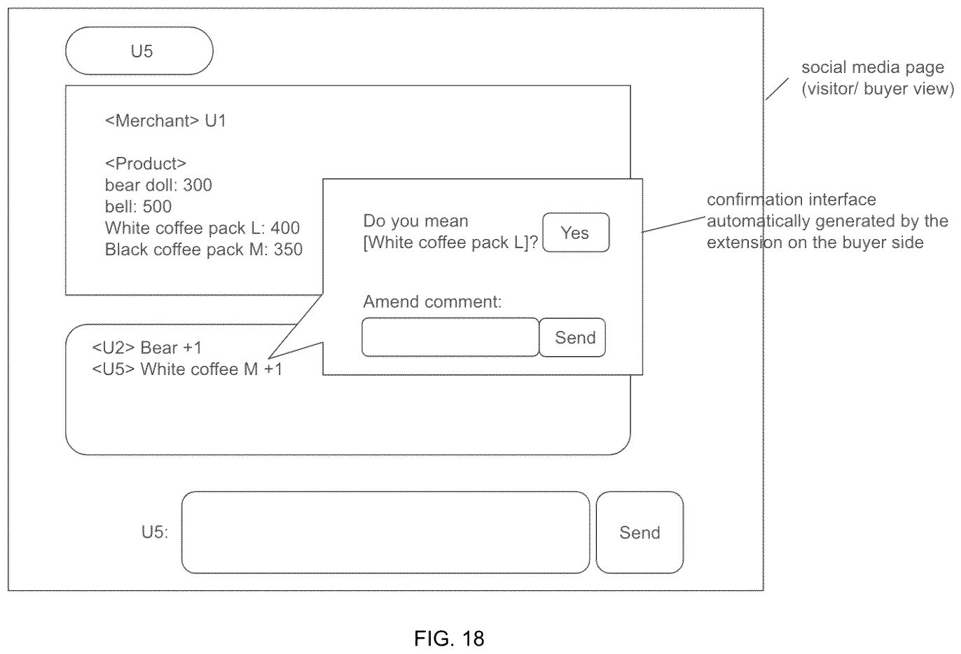

FIG. 18 shows an example of a social media page from the buyer view according to some embodiments of the present disclosure.

FIG. 18 is similar to FIG. 16, except that the analysis/confirmation of the purchase comment is performed by the plugin installed on the user terminal of user U5 (the buyer). The buyer side plugin analyzes the comment and finds it inconsistent with the item DB (which could be on the user terminal of user U5). The buyer side plugin then generates a confirmation interface to confirm the order with user U5. User U5 may click [yes] to confirm the order or may amend the purchase content in the interface.

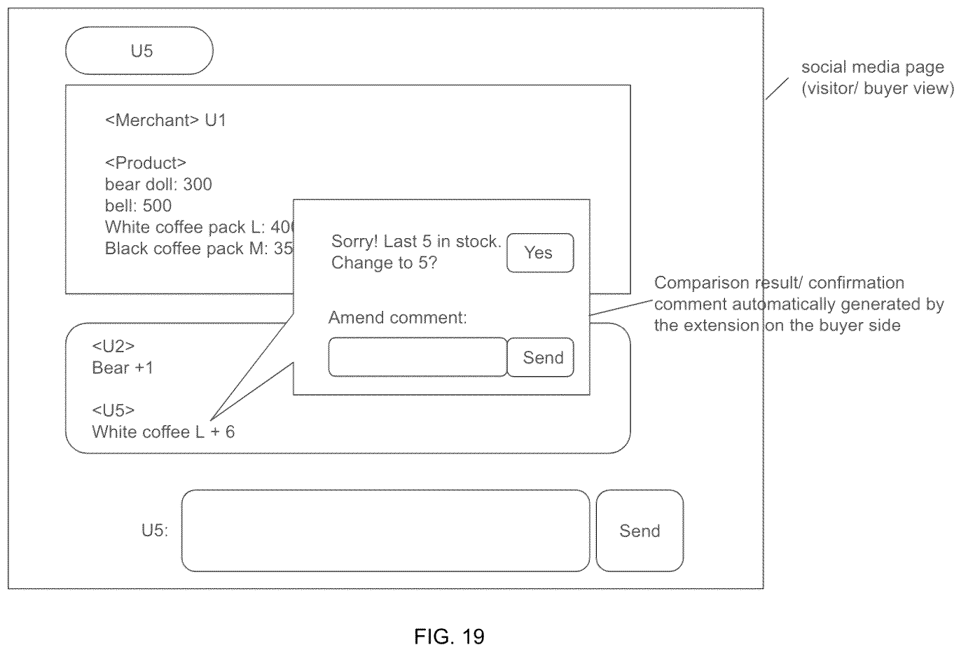

FIG. 19 shows an example of a social media page from the buyer view according to some embodiments of the present disclosure.

FIG. 19 is similar to FIG. 17, except that the analysis/confirmation of the purchase comment is performed by the plugin installed on the user terminal of user U5 (the buyer). The buyer side plugin accesses the order management server's stock DB and finds out the stock is not enough for the order. The buyer side plugin then generates a confirmation interface to confirm the order with user U5. User U5 may click [yes] to confirm the new order or may amend the purchase content in the interface.

In some embodiments, the plugin or the extension could be generated and/or stored at the order management server 10. The plugin may then be uploaded to the download server 280, for the user terminals 20 or 30 to download. In some embodiments, the order management server 10 may include a notifying unit for notifying a seller to download the plugin into the user terminal to utilize the order management service.

In existing Social Network Services such as Facebook or Instagram, some users of SNS sell products through posts or chats or video. SNS itself usually does not provide means for e-commerce like order management or transactions; therefore, the users redirect buyers to their website with e-commerce function or use dedicated software to manage orders in SNS such as OrderPally.

The dedicated software obtains text data in the conversation between the seller and the buyer(s) by directly communicating with server(s) hosting SNS through Application Programing Interfaces provided by SNS.

This scheme is convenient in that SNS itself does not have to implement the e-commerce function yet the users of SNS still can easily conduct e-commerce on SNS. However, as a provider of the dedicated software, there is a risk that the APIs become unavailable for some reasons like increase of cost or termination of service. There is a need for an alternative solution for the dedicated software to continue its service to the users regardless of SNS's APIs.

Some embodiment of the present disclosure provides an extension program to a web browser of a user terminal. The extension program, when installed, causes the “export” button to appear on the post of SNS which is rendered by the web browser of a seller's terminal. The export button will not be shown on the post of SNS which is rendered by the web browser of a buyer's terminal. Upon detection of designation on the export button, the extension program retrieves the html data for the post of SNS where the export button was located, and analyzes the html data to extract comments from buyer(s). Then the extension program transmits, via a network and to a server which is different from server(s) hosting SNS, the extracted comments or any data derived from the extracted comments. The server receives the extracted comments and registers, updates or deletes order information based on the contents of the extracted comments.

In some embodiment of the present disclosure, the seller on SNS has a group comprising a plurality of posts, each post is associated with at least one product. In one embodiment, the export button may be implemented in each of the posts in the group of the seller, so that the seller can choose which post/product he/she would like to manage orders. In another embodiment, there is just one export button on the group top page in SNS. Upon detection of designation on the export button, the extension program automatically retrieves the html data for all the posts under the group.

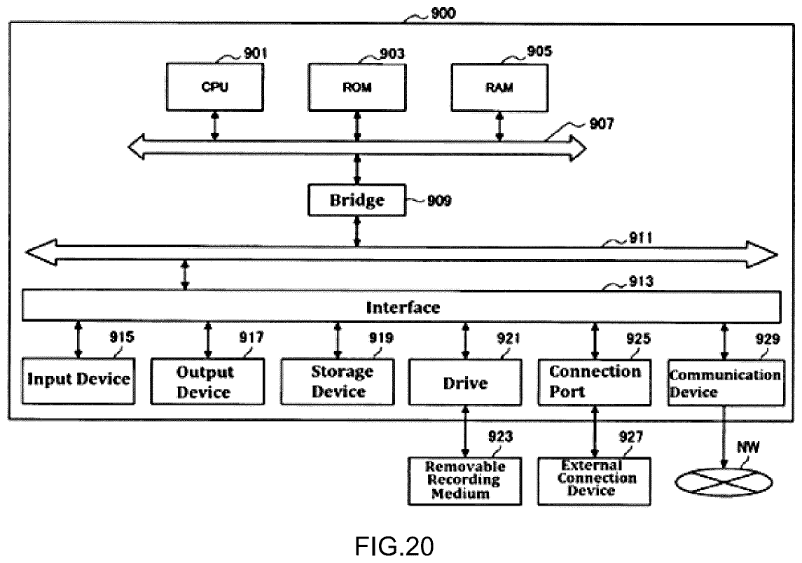

Referring to FIG. 20, the hardware configuration of the information processing device will be now described. FIG. 20 is a block diagram showing an example of a hardware configuration of the information processing device according to some embodiments of the present disclosure. The illustrated information processing device 900 may, for example, realize the server 10 and/or the user terminals 20 and 30 in some embodiments.

The information processing device 900 includes a CPU 901, ROM (Read Only Memory) 903, and RAM (Random Access Memory) 905. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). In addition to or instead of the CPU 901, the information processing device 900 may also include a DSP (Digital Signal Processor) or ASIC (Application Specific Integrated Circuit).

The CPU 901 functions as an arithmetic processing device and a control device, and controls all or some of the operations in the information processing device 900 according to various programs stored in the ROM 903, the RAM 905, the storage device 919, or the removable recording medium 923. For example, the CPU 901 controls the overall operation of each functional unit included in the server 10 and the user terminals 20 and 30 in some embodiments. The ROM 903 stores programs, calculation parameters, and the like used by the CPU 901. The RAM 905 serves as a primary storage that stores a program used in the execution of the CPU 901, parameters that appropriately change in the execution, and the like. The CPU 901, ROM 903, and RAM 905 are interconnected to each other by a host bus 907 which may be an internal bus such as a CPU bus. Further, the host bus 907 is connected to an external bus 911 such as a PCI (Peripheral Component Interconnect/Interface) bus via a bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OLED, etc., a sound output device such as a speaker and headphones, and a printer. The output device 917 outputs the results of processing by the information processing device 900 as text, video such as images, or sound such as audio.

The storage device 919 is a device for storing data configured as an example of a storage unit of the information processing device 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for a removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 905. Further, the drive 921 writes records in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is an imaging element such as a CCD (Charge Coupled Device) or CMOS (Complementary Metal Oxide Semiconductor), and a device that captures an image of the real space using various elements such as lenses for controlling image formation of a subject on the imaging element to generate the captured image. The image capturing device may capture a still image or may capture a moving image.

The configuration and operation of the live streaming system 1 in the embodiment have been described. This embodiment is a mere example, and it is understood by those skilled in the art that various modifications are possible for each component and a combination of each process, and that such modifications are also within the scope of the present disclosure.

The processing and procedures described in the present disclosure may be realized by software, hardware, or any combination of these in addition to what was explicitly described. For example, the processing and procedures described in the specification may be realized by implementing a logic corresponding to the processing and procedures in a medium such as an integrated circuit, a volatile memory, a non-volatile memory, a non-transitory computer-readable medium and a magnetic disk. Further, the processing and procedures described in the specification can be implemented as a computer program corresponding to the processing and procedures, and can be executed by various kinds of computers.

Furthermore, the system or method described in the above embodiments may be integrated into programs stored in a computer-readable non-transitory medium such as a solid state memory device, an optical disk storage device, or a magnetic disk storage device. Alternatively, the programs may be downloaded from a server via the Internet and be executed by processors.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed, but includes another variation and modification that do not disobey the present disclosure, and is the scope covered by the patent application scope.

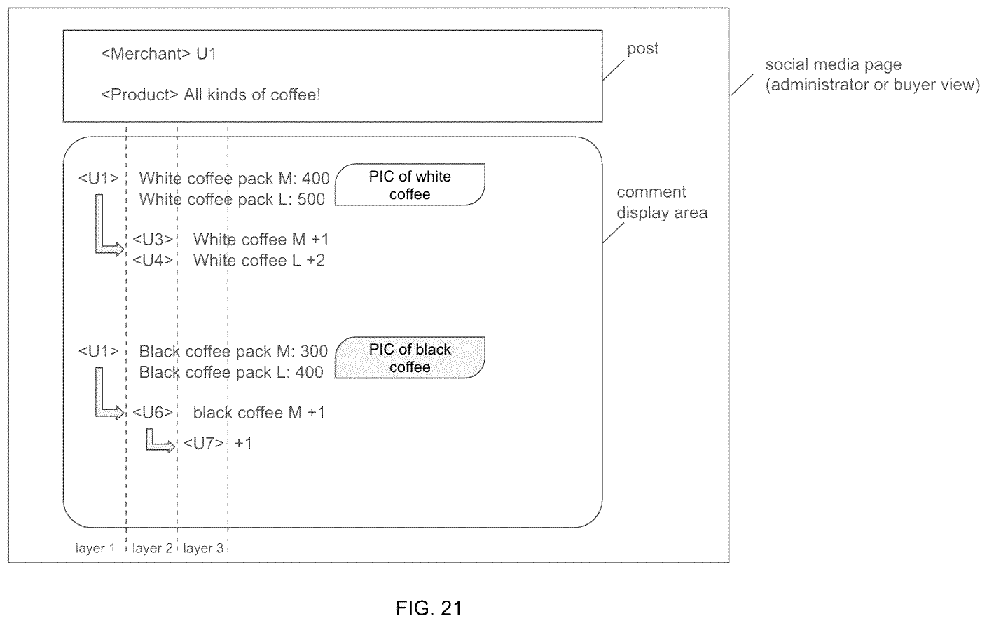

FIG. 21 shows an example of a social media page according to some embodiments of the present disclosure. The user interface could correspond to an administrator (or seller/merchant) view or a buyer view.

The post is created by user U1, and contains general information about products to be sold. The comment display area has multiple layers. The seller, such as user U1, may create sales comments containing product information at layer 1. The sales comments start at layer 1 and the product information may contain specs or pictures about multiple products. Buyers, such as U3, U4, U6 or U7, may create order comments at subsequent layers by replying to the sales comments. The order comments from users U3, U4 or U6 start at layer 2, and contain the order information including the product name and the order number. The order comment from user U7 starts at layer 3, because user U7 creates the order comment by replying to the order comment from user U6. User U7 may not specify details of order information, because the order information will be analyzed based on the comment user U7 replies to.

The processing unit 234 at the user terminal side may extract/analyze the webpage data (such as HTML data) of the social media page, to determine the sales and order information, and to transmit that information to server 10. The processing unit 234 may utilize/analyze the layer information and the content of each comment to determine whether the comment is a sales comment or an order comment. For example, a comment starting at layer 1 and/or containing sales information (such as a keyword about sales/products) may be determined to be a sales comment. For example, a comment starting at layer 2 or layer 3, and/or containing order information (such as a keyword about product/order number) may be determined to be an order comment. The processing unit 234 may then transmit all order information to server 10.

In some embodiments, comments starting at different layers may have different tags or prefixes in the webpage data. The tags or prefixes could be used by the processing unit 234 to distinguish the layers of different comments. In some embodiments, a user not registered as seller/administrator cannot leave comments at layer 1.

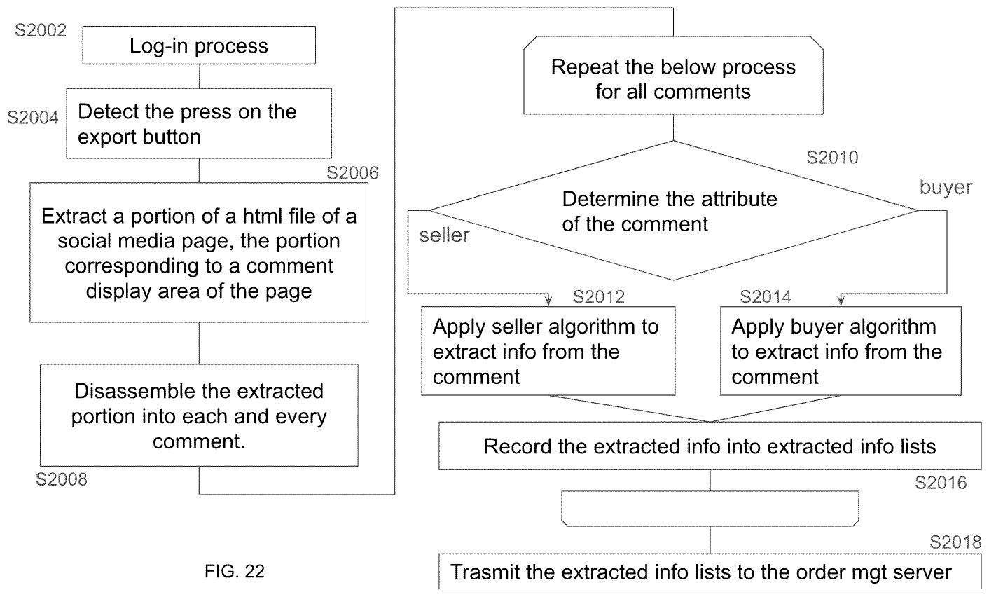

FIG. 22 shows a flowchart showing a process to generate data from comments at the user terminal with the plugin to the browser according to some embodiments of the present disclosure. At step 2002, the plugin in the user terminal may perform the log-in process as is described in this specification, for example, by referring to FIGS. 10, 11 and 12. At step S2004, the plugin in the user terminal may detect the press on the export button, as is described in this specification with respect to FIG. 13.

At step S2006, the plugin in the user terminal, in response to detecting the press on the export button, may extract a comment portion of the html file of the social media page, such as that shown in FIG. 21. The extracted comment portion corresponds to the comment display area of the social media page. At step S2008, the plugin may disassemble the extracted portion into each and every comment. Data of each extracted comment may contain (i) the body/content of the comment, (ii) the user ID of the user who posted the comment, (iii) timestamp indicating when the comment was posted, (iv) the layer or the depth to which the comment belongs and (v) the relationship between the comment and other comments. The relationship may include dependency. The layer and the dependency of comments may be obtained by the plugin analyzing the extracted portion using, for example, DOM (Document Object Model).

After the disassemblement at step S2008, the steps S2010, S2012/S2014 and S2016 may be repeated for each and every comment until all the comments are processed. At step S2010, the plugin in the user terminal may determine the attribute of the comment. In some embodiments, the attribute of a comment is either seller-type or buyer-type. Assuming that, in the comment display area of the social media page, the seller first provides a post/comment to show product information (price, picture, stock quantity, details, etc.) and any buyer who wants to buy the product would reply to the post/comment, the plugin determines that a comment belonging to the layer 1 is a candidate seller type comment. The plugin then determines whether the candidate seller type comment is seller-type one or not by keyword-matching. If the keyword-matching result indicates that the comment is not seller-type, then the plugin determines that said comment is a candidate buyer-type comment. The plugin determines whether this candidate buyer-type comment (belonging to the layer 1) is buyer-type or not by keyword-matching. If the comment is determined to be neither seller-type nor buyer-type, such comment is neglected and will not be further processed. The plugin determines that a comment belonging to the layer 2 or deeper is a candidate buyer type comment. The plugin then determines whether the candidate buyer type comment is buyer-type one or not by keyword-matching. If the keyword-matching result indicates that the comment is not buyer-type, then the plugin determines that said comment is a candidate seller-type comment. The plugin determines whether this candidate seller-type comment (belonging to the layer 2 or deeper) is seller-type or not by keyword-matching. If the comment is determined to be neither seller-type nor buyer-type, such comment is neglected and will not be further processed.

In the process of determining the attribute of the comment, the user ID of the comment (indicating who posted the comment) may or may not be used. In one embodiment, a criteria where any comment made by the seller is classified as seller-type and the rest of the comment is classified as buyer-type may be used. In other embodiments, there may be a situation where the seller cooperates with another user (helper) to sell products in the social media, in which case a user having a user ID other than the seller does not always tell that said user is buyer-side. In such a case, combination of layer/depth and keyword matching as is described above may be used.

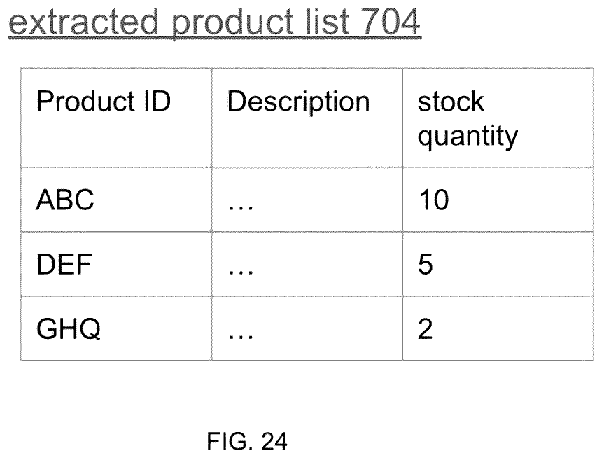

If the comment is determined to be seller-type at step S2010, the process proceeds to step S2012 where the plugin applies a seller algorithm to the comment to extract information from the comment. In some embodiments, the seller algorithm is configured so that (i) product ID which identifies the product to be sold by the seller, (ii) description of the product and (iii) stock quantity of the product are identified from the comment. At step S2016, the plugin records the extracted information into extracted product list 704. FIG. 24 shows data structure of an exemplary extracted product list 704. The extracted product list 704 associatively stores the product ID of the product, description of the product and the stock quantity of the product.

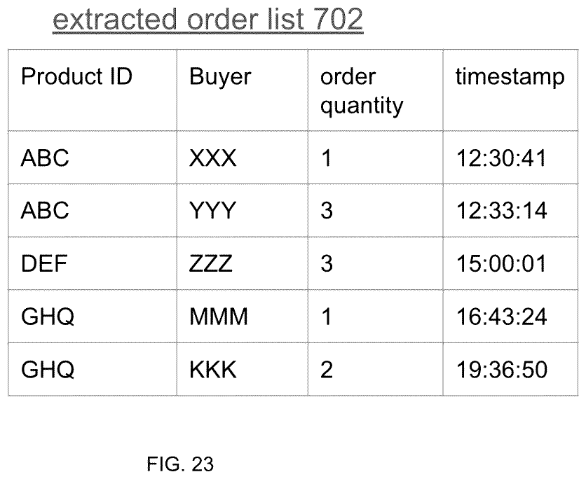

If the comment is determined to be buyer-type at step S2010, the process proceeds to step S2014 where the plugin applies a buyer algorithm to the comment to extract information from the comment. In some embodiments, the buyer algorithm is configured so that (i) product ID which identifies the product to be sold to the buyer, (ii) user ID of the buyer, (iii) order quantity and (iv) timestamp indicating when the comment corresponding to the order is made are identified from the comment. The buyer algorithm uses the user ID of the user who posted the comment to determine the user ID of the buyer. The buyer algorithm uses the relationship between comments to determine the product ID. For example, if the buyer-type comment depends on a parent seller-type comment, the product ID of the buyer-type comment is determined to be the product ID which is associated with the parent seller-type comment. At step S2016, the plugin records the extracted information into extracted order list 702. FIG. 23 shows data structure of an exemplary extracted order list 702. The extracted order list 702 associatively stores the product ID of the sold product, the user ID of the buyer, the order quantity and the timestamp.

At step S2018, the plugin of the user terminal may transmit the extracted information lists (including the extracted product list 704 and the extracted order list 702) to the order management server.

By determining the attribute of the comment and extracting information from the comment using an algorithm corresponding to the determined attribute, it becomes possible to extract necessary information with higher accuracy and completeness. For example, even if the comment display area has multiple layers, the plugin can classify the comment into seller-type or buyer-type and can extract necessary order information according to the classification.

In other embodiments, any attribute such as helper-type, male/female, frequent buyer/newbie or young/old may be used. An algorithm to analyze the comment can be selected according to the determined attribute.

In other embodiments, a function realized in the user terminal may be realized in the order management server. For example, any one of the steps S2006, S2008, S2010, S2012, S2014 and S2016 or any combination thereof may be implemented in the order management system. In such a case, the html file of the social media page or the portion of the html file corresponding to the comment display area or the comments may be transmitted to the order management server by the plugin of the browser of the user terminal.

What is claimed is:

1. A method for order management through a plugin, comprising:
displaying an object associated with a post on a website supported by a first server on a user terminal of a first user;
detecting the first user to have selected the object;
transmitting a purchase comment from a second user and related to the post to a second server,
wherein the first server is different from the second server.

2. The method according to claim 1, wherein the website is accessed by an application of the user terminal of the first user, and the plugin is installed into the application.

3. The method according to claim 1, wherein the object is displayed along with the post on the website.

4. The method according to claim 1, further comprising:
determining a content on the website to have met a predetermined criterion; and
displaying the object in response to determining the content to have met the predetermined criterion.

5. The method according to claim 4, further comprising:
obtaining an identifier from the first user, the identifier associated with the website and the second server,
wherein the displaying the object associated with the post on the website is in response to the obtaining the identifier.

6. The method according to claim 1, further comprising:
determining a portion of the purchase comment to be inconsistent with a set of items;
determining a first item in the set of items to be correlated with the portion of the purchase comment; and
generating a confirmation comment with respect to the post, wherein the confirmation comment includes the first item.

7. The method according to claim 6, further comprising:
determining a confirmation result with respect to the confirmation comment has been generated by the second user on the website; and
transmitting the confirmation result to the second server.

8. The method according to claim 1, further comprising:
obtaining stock data from the second server;
performing a comparison between multiple purchase comments, from multiple users and related to the post, and the stock data; and
generating a result of the performing the comparison on the website.

9. The method according to claim 1, wherein the first server is a social media server, and the second server is an order management server.

10. A terminal for order management, comprising one or a plurality of processors, wherein the one or plurality of processors execute a browser plugin to perform:
displaying an object associated with a post on a website supported by a first server on a user terminal of a first user;
detecting the first user to have selected the object;
transmitting a purchase comment from a second user and related to the post to a second server,
wherein the first server is different from the second server.

11. A non-transitory computer-readable medium including a plugin program for order management, wherein the plugin program causes one or a plurality of computers to execute:
displaying an object associated with a post on a website supported by a first server on a user terminal of a first user;
detecting the first user to have selected the object;
transmitting a purchase comment from a second user and related to the post to a second server,
wherein the first server is different from the second server.
